(19) United States
(12) Patent Application Publication
(10) Pub. No.: US 2025/0078672 A1
(43) Pub. Date: Mar. 6, 2025

(54) REINFORCEMENT LEARNING METHOD FOR EDUCATIONAL COURSE SELECTION

(71) Applicant: KING FAISAL UNIVERSITY, AL-AHSA (SA)

(72) Inventors: THEYAZN HASSN HADI ALDHYANI, AL-AHSA (SA); MOSLEH HMOUD AL-ADHAILEH, AL-AHSA (SA); M. IRFAN UDDIN, AL-AHSA (SA); SAMINA AMIN, AL-AHSA (SA); WALI KHAN MASHWANI, AL-AHSA (SA)

(21) Appl. No.: 18/242,142

(22) Filed: Sep. 5, 2023

(51) Int. Cl. G09B 5/00; G06Q 50/20

(52) U.S. Cl. CPC G09B 5/00; G06Q 50/205

(57) ABSTRACT

A reinforcement learning (RL) method for educational course selection includes the following steps: a) an action space and a state space are established, where actions of the action space represent actions associated with educational material and states of the state space represent learning states associated with a student; b) an action is selected from the action space; c) a next state is calculated based on the selected action and a current state; d) a reward is generated based on the current state and the next state; e) a Q-value is updated in a corresponding position in a Q-value table based on the reward; and f) the state is updated and the process returns to step b) when a final state is not reached, and an optimized action is output to the student when the final state is reached. The optimized action represents an educational course recommendation.

### BACKGROUND OF THE INVENTION

### Field of the Invention

The disclosure of the present patent application relates to selection of educational courses, such as particular classes, educational course material and the like, and particularly to the use of reinforcement learning (RL) methods for recommending educational courses to students.

### Description of Related Art

RL is commonly used in games to understand the complex scenario of games and how to reach a winning state. However, expansion into other areas, particularly where human preferences and choices are involved, is difficult. The potential of RL to provide recommendations in a complex social setting, such as with online learning and choosing courses, is clear, though complex to implement.

For example, in order to recommend courses to individuals in an online learning environment, a RL system will have to understand the complex sequential decision processes involved in learning, particularly as represented by states and actions, followed by taking optimal actions based on the needs of the user (represented by rewards), resulting in an optimal choice of a learning curriculum. The rewards should consider both short-term and long-term goals, and the objective would be to collect maximum possible rewards to make sure that the user is learning effectively and making good progress. The application to online learning, particularly in a massive open online course (MOOC) platform, is inherently a multi-agent process, thus making the techniques even more difficult to implement.

Until now, course decisions in MOOC platforms have overwhelmed students with information, resulting in dropouts and failures. It would be advantageous to be able to provide the benefits of RL to course recommendation based on the students' needs, preferences, capabilities and learning styles. At present, little progress has been made in applying RL to such a complex social environment. Thus, a RL method for educational course selection solving the aforementioned problems is desired.

### SUMMARY OF THE INVENTION

The RL method for educational course selection uses RL to recommend an educational course to a student based on observed student behavioral characteristics. In one embodiment, the Q-learning algorithm is used to recommend educational courses to the student. In this method, a) an action space and a state space are established, where actions of the action space represent actions associated with educational material and states of the state space represent learning states associated with a student; b) an action is selected from the action space; c) a next state is calculated based on the selected action and a current state; d) a reward is generated based on the current state and the next state; e) a Q-value is updated in a corresponding position in a Q-value table based on the reward; and f) the state is updated and the process returns to step b) when a final state is not reached, and an optimized action is output to the student when the final state is reached. The optimized action represents an educational course recommendation. Selection of the action may include an exploration process using a greedy strategy or an exploitation process using a greedy strategy.

The Q-learning embodiment may be extended to a multi-agent system, particularly using Multi-Agent Q-learning, which is an extension of the traditional Q-learning algorithm that allows multiple agents to interact and learn in an environment. For each agent, a Q-table is initialized that stores the estimated Q-values (i.e., the expected cumulative rewards) for each state-action pair. Multiple episodes of interaction and Q-value updates are repeated to converge to an optimal or near-optimal policy. For each time step, each agent selects an action based on its Q-values and the exploration-exploitation strategy, similar to the previous embodiment. Each agent can obtain its policy by selecting the action with the highest Q-value in each state, and then the learned policies are combined in the final loop to maximize the cumulative reward. Once each agent has learned its policy independently, these policies can be combined in various ways to improve overall performance or coordination among agents.

In an alternative embodiment, a Deep Q-learning algorithm is used in which a deep neural network is used to represent the Q-function, rather than the Q-value table of the previous embodiment. In this embodiment, a) an action space and a state space are established, where actions of the action space represent actions associated with educational material and states of the state space represent learning states associated with a student; b) a current action of the action space and a current state of the state space are initialized; c) a next state is calculated based on the current action and the current state; d) a next action is generated based on the next state; e) the next action is updated based on a reward; f) a loss function is calculated based on the updated next action and a target state-action value; a weight of the loss function is updated using gradient descent; and h) the state and is updated and the process returns to step b) when a final state is not reached, and an optimized action is output to the student when the final state is reached, where the optimized action represents an educational course recommendation.

The Deep Q-learning algorithm-based embodiment may be extended to a multi-agent implementation. In such an embodiment, the students and course content/material make up the environment and the roles of the agents are handled by deep reinforcement learning (DRL) algorithms. In the context of DRL, an Actor-Critic algorithm is utilized, where the actor represents the policy, which is a mapping from states to actions. This algorithm tries to learn the optimal policy that maximizes the expected cumulative reward over time. The critic, on the other hand, represents the value function, which estimates the expected cumulative reward from a particular state under the current policy. The key idea in Actor-Critic is to use the critic's value function to evaluate the actor's policy. The critic provides feedback to the actor about the expected reward for a given state-action pair. The actor then uses this feedback to adjust its policy to select better actions in each state, leading to improved performance. In this embodiment, the state is given as a feature depiction for students, and action is defined as a feature depiction of course content. When a student wants a course, the agents are given a state representation (i.e., student's features) and a collection of action representations (i.e., the course competitors' features). The agents choose the best course of action (e.g., recommend a list of course content to a student) and reward the learner with feedback. The reward is made up of click labels and an estimate of the student's activity level. All these recommendations and feedback reports are saved in the agents' memory. The agent uses the data in memory to update its recommendation algorithm at every iteration. The model is trained using the collected data and the defined reward function. The training process can involve several iterations and hyperparameter tuning to optimize performance, similar to the single agent Deep Q-learning algorithm-based embodiment.

As a further alternative, a Multi-Agent Deep Q-learning (MADQN) structure may be used, which is an extension of Deep Q-learning for environments with multiple agents. This structure involves multiple agents interacting with the environment and learning their policies using deep neural networks to approximate the Q-values. The algorithm uses neural networks to approximate the Q-values and allows agents to learn from each other's experiences. For example, each agent learns from its own experiences and those of its teammates or opponents, making the learning process more complex compared to single-agent DQN. For each time step, each agent selects an action based on its Q-network and the exploration-exploitation strategy. The agents take their actions in the environment, and the environment responds with the next states and rewards for each agent. Each agent stores its experiences in the shared experience replay buffer, similar to the single-agent Deep Q-learning embodiment discussed above. Each agent can execute its policy independently, and then the learned policies are combined in the final loop to maximize the cumulative reward. Once each agent has learned its policy independently, these policies can be combined in various ways to improve overall performance or coordination among agents, similar to the single-agent Deep Q-learning embodiment discussed above.

These and other features of the present subject matter will become readily apparent upon further review of the following specification.

### BRIEF DESCRIPTION OF DRAWINGS

FIG. 1 is a block diagram showing method steps of the RL method for educational course selection.

FIG. 2 is a block diagram showing method steps of an alternative embodiment of the RL method for educational course selection.

Similar reference characters denote corresponding features consistently throughout the attached drawings.

### DETAILED DESCRIPTION

The RL method for educational course selection provides personalized adaptive learning and course content recommendations to students. The framework for the RL method is divided into two main components: a student agent and a recommendation agent. The student agent is responsible for modelling each student's behaviors, learning style, preferences, competence, adaptive difficulty levels, optimal learning paths, personalized feedback, interest in social media, frustration and disengagement, and knowledge level over time. The student agent uses RL and DRL algorithms with Markov decision process (MDP) terminologies to learn from the student's interactions with the system and adapt to their changing needs or preferences. The recommendation agent uses the information learned by the student agent to recommend a personalized adaptive sequential learning path and course content to a student based on their preferences, behavior, knowledge level, etc.

The RL method for educational course selection begins with initialization of the action (a) and states (S) of the agents. This can be represented as a tuple: {N, S, A₁, . . . , A_{N}, P, R₁, . . . , R_{N}}, where N is the number actions; S is the environment state, s∈S; A_{N} represents the action space n, aₙ∈Aₙ where n=1, 2, . . . , N; P represents the state transition, where P: S×A₁× . . . ×Aₙ×S; and R_{N} represents the rewards achieved by executing aₙ∈A_{N} in S, where n=1, 2, . . . , N.

Following initialization, the action (a) space operates for several periods (or cycles) among all of the states by multiple agents. The interaction between the agents and the environment is simulated by allocating a reward (Rₜ) to a chosen a in each S to update the action-value function Q(sₜ, aₜ) for each content by using equation (1) below, where the agent just cares about the current state of the process and has no curiosity about the entire history or previous records when a new student is registered or new information is added to the system in order to tackle the cold-start problem. Furthermore, the agent can dynamically model user preferences by interacting with users and obtaining feedback to capture their interest drift in real-time, thus better solving the classical key issues (cold start, gray sheep, and sparsity) faced by traditional recommender systems. Equation (1) is as follows:

$${Q}_{n} ( {s}_{t} , {a}_{t} ) = {Q}_{n} ( {s}_{t} , {a}_{t} ) + α [ {R}_{t} + γ {max}_{a} {Q}^{′} ( {s}_{t + 1} , {a}_{t + 1} ) - Q ( {s}_{t} , {a}_{t} ) ] . \qquad ( 1 )$$

In equation (1) above, the Qₙ(sₜ, aₜ) on the left side of the equation represents the new Q-value estimation, and the two Qₙ(sₜ, aₜ) expressions on the right side of the equation represent the current Q-value. α is the learning rate, Rₜ is the reward, γ is the discount factor, and the entire expression γ maxₐ Q′(sₜ₊₁, aₜ₊₁) is the discounted estimated Q-value of the next state. The discount factor γ represents the discount rate and determines how important current and future rewards are. For example, the discount factor γ depicts how much the agent cares about rewards in the distant future relative to those in the immediate future. γ has a value between 0 and 1. A lower value of γ encourages short-term rewards, while a higher value of γ promises a long-term reward.

Equation (1) represents the following process: for the set of states s, the set of actions a, and the set of rewards R, at each time step t=0, 1, 2, . . . , some representation of the environment's state sₜ∈S is received by the agent. According to this state, the agent selects an action aₜ∈a, and the representation of the environment's state sₜ and the action aₜ form the state-action pair (sₜ, aₜ). In the next time step t+1, the transition of the environment occurs and the new state sₜ₊₁∈S is achieved. At this time step t+1, a reward Rₜ∈R is received by the agent for the action aₜ taken from state sₜ.

The combined Q value based on student preferences will be updated based on the student's experiences with the system by using equation (2):

$$Q ( s + a ) = 𝔼 [ {\sum }_{τ = 0}^{∞} {γ}^{τ} {R}_{τ} \vert {s}_{τ} = s , {a}_{τ} = a ] = {\sum }_{n = 0}^{N} 𝔼 [ {\sum }_{τ = 0}^{∞} {γ}^{τ} {R}_{n , t + τ} \vert {s}_{τ} = s , {a}_{τ} = a ] = {\sum }_{n = 0}^{N} {Q}_{n} ( s , {a}_{n} ) . \qquad ( 2 )$$

In equation (2) above, the operator [symbol] represents the expected cumulative reward. The expected cumulative reward, in the context of RL, refers to the sum of rewards that a RL agent expects to receive over a sequence of actions taken in an environment. This expected cumulative reward represents the long-term reward that the agent aims to maximize through its decision-making process.

In the present context of recommending educational courses and coursework, the overall framework is based on various learning states of the students. The learning states may be seen as activities engaged in by a student, or the emotional/physical state of the student, in an online learning scenario. For example, the states may include watching a video lesson, reading, writing, getting bored, resting/sleeping, being entertained, playing a game, clicking on an ad, completing a course, and quitting/ending study. The states may be represented as S∈{0, 1, 2, 3, 4, 5, 6, 7, 8, 9, 10}, where each number state reflects the position of each student during the learning process.

The input to the overall system is the set of states, such as in the limited number of examples given above, and their corresponding reward values. Examples of the corresponding actions include recommending the next course, recommending the next video to watch, recommending a game or an ad, suggesting a future influence for personalized learning, making an improvement in recommending suitable content, influencing future learning choices, and attempting to maximize the student's satisfaction and minimize student interactions. The purpose of the RL process is to design personalized adaptive paths by minimizing negative experiences.

After the states and actions are input, the reward mechanism is formed. As a non-limiting example, the reward may be set to a maximum of 100; i.e., if learning proceeds without interruption during all iterations, the maximum reward will be 100, as depicted in the matrix of equation (3) below. The matrix of equation (3) represents the actual input in the form of reward values for each state-action pair. The starting component of the initialized probabilities is also this matrix. The matrix's columns represent actions, and the rows represent states. The matrix of the ideal learning path can be generated by setting the feedback value at 0.75 and the model is subjected to rigorous training over several episodes, for example.

$$P = \begin{matrix}{S}_{0} \\ {S}_{1} \\ {S}_{2} \\ {S}_{3} \\ {S}_{4} \\ {S}_{5} \\ {S}_{6} \\ {S}_{7} \\ {S}_{8} \\ {S}_{9} \\ {S}_{10}\end{matrix} ( \begin{matrix}{A}_{1} & {A}_{2} & {A}_{3} & {A}_{4} & {A}_{5} & {A}_{6} & {A}_{7} & {A}_{8} \\ 10 & 0 & 50 & 0 & 0 & 0 & 70 & - 10 \\ 10 & 0 & 50 & 60 & 100 & 0 & 0 & 0 \\ 10 & 0 & 50 & 0 & 0 & 0 & 0 & - 10 \\ 0 & 20 & 0 & 60 & 100 & 0 & 0 & - 10 \\ 0 & 20 & 50 & 60 & 100 & 100 & 70 & 0 \\ 0 & 20 & 50 & 60 & 0 & 0 & 0 & - 10 \\ 10 & 0 & 50 & 0 & 0 & 0 & 0 & 0 \\ 10 & 0 & 50 & 60 & 100 & 100 & 70 & 0 \\ 0 & 20 & 0 & 60 & 0 & 0 & 0 & - 10 \\ 0 & 20 & 0 & 60 & 0 & 0 & 70 & 0 \\ 10 & 20 & 50 & 60 & 100 & 100 & 70 & - 10\end{matrix} ) \qquad ( 3 )$$

As is well known in the field of RL, the reward is a fundamental variable and an essential component of the RL method. The reward represents the feedback or evaluation signal that the RL agent receives from the environment based on its actions and the resulting states. The reward is not typically provided as an input to the RL model, rather, it is obtained as an output from the environment after the agent takes an action. The RL agent uses this reward to update its policy or value estimates, aiming to maximize the cumulative rewards it receives over time. While the reward itself is not directly input into the RL model, the agent's learning algorithm utilizes the reward information to guide the model's training process. The RL algorithm, such as the Q-learning algorithm used above or, alternatively policy gradients or actor-critic methods, incorporates the reward signal into its update rules to update the model's parameters.

In the deep RL method for educational course selection, the exploration techniques will be applied to the process of trying new actions or policies to gather more information about the learning environment in order to maintain the students' preferences in the future and influences on future learning choices/decisions. On the other hand, exploitation techniques will be applied to the process of using the current knowledge or preference level of the learner to make decisions that maximize the expected cumulative reward. In general, in DRL, a RL agent must balance the exploration/exploitation tradeoff; i.e., the problem of deciding whether to pursue actions that are already known to yield high rewards or explore other actions in order to discover higher rewards. RL agents usually collect data with some type of stochastic policy, such as a Boltzmann distribution in discrete action spaces or a Gaussian distribution in continuous action spaces, inducing basic exploration behavior. The idea behind novelty-based, or curiosity-driven, exploration is giving the agent a motive to explore unknown outcomes in order to find the best solutions. This is done by modifying the loss function (or even the network architecture) by adding terms to incentivize exploration. An agent may also be aided in exploration by utilizing demonstrations of successful trajectories, or reward-shaping, giving an agent intermediate rewards that are customized to fit the task it is attempting to complete.

As an example, supposing that an agent is given the task of recommending personalized content to improve the student's learning activities by maximizing long-term rewards to reach a goal, then the agent has two options: it can either recommend course content/material that it has previously recommended and is familiar with using exploitation techniques, or it can try a new personalized content that it has never taken before by using exploration techniques.

In the context of an online learning platform, finding the optimal action to maintain a long session translates to maximizing long-term rewards and recommendation accuracy such that the students' learning progress is maximized while minimizing their frustration and disengagement. The present method simulates the learning material/content by classifying the student's adaptive sequential behavior, learning style/paths, learning activities, various learning materials, adaptive difficulty levels, optimal learning paths, personalized feedback, preferences, competence, and knowledge level simultaneously according to the states-actions features. Non-limiting examples of states-actions features which may be used are reading, writing, taking exams, pausing, watching, skipping, or stopping (video lessons, audio lessons, images, slides, notes, quizzes, assignments and/or writing), getting bored, rest/sleep, entertaining, playing games, idle, project, short code, and quit study. The measured student interests or preferences will then be averaged by the number of times that the agents acquired the same state (S) transition and the averaged values.

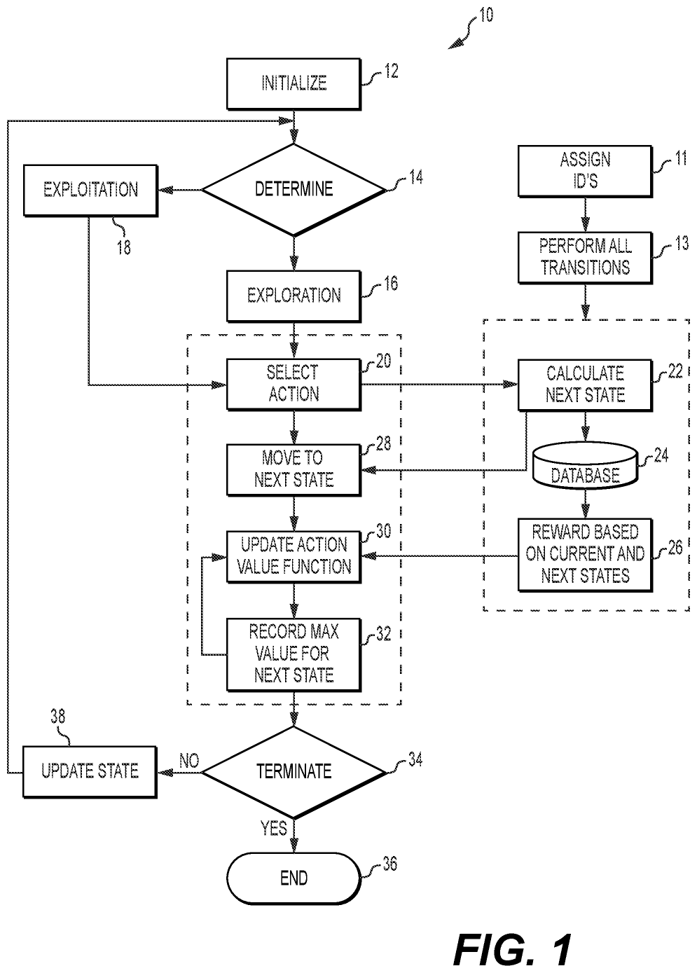

As shown in FIG. 1, the RL method for educational course selection 10, which is a Q-learning implementation, begins at step 12 with the initialization of the Q-value function, which is given by equation (1) above, which is the state and action value function based on the initial inputs of states and corresponding actions. As discussed above, as non-limiting examples, the learning states may be seen as activities engaged in by a student, or the emotional/physical state of the student, in an online learning scenario. For example, the states may include watching a video lesson, reading, writing, getting bored, resting/sleeping, being entertained, playing a game, clicking on an ad, completing a course, and quitting/ending study. The states may be represented as S∈{0, 1, 2, 3, 4, 5, 6, 7, 8, 9, 10}, where each number state reflects the position of each student during the learning process. Non-limiting examples of the corresponding actions include recommending the next course, recommending the next video to watch, recommending a game or an ad, suggesting a future influence for personalized learning, making an improvement in recommending suitable content, influencing future learning choices, and attempting to maximize the student's satisfaction and minimize student interactions.

At step 11, identification (ID) numbers are allocated to all of the action (a) forms (e.g., click reading, click writing, recommend a quiz, click a video, recommend the next course, recommend a game, click an ad, etc.), and all the state (S) transitions (e.g., reading, writing, taking exams, pausing, watching, skipping or stopping, getting bored, resting/sleeping, being entertained, playing games, being idle, quitting study, etc.) will be operated for several periods among all the IDs by multiple agents at step 13.

A determination is made at step 14 whether exploration or exploitation will be used. As is well known in RL, exploration techniques (step 16) are applied to the process for trying new actions or policies to gather more information about the learning environment in order to maintain the students' preferences in the future and influence on future learning choices/decisions. On the other hand, exploitation techniques (step 18) are applied to the process for using the current knowledge or preference level of the student to make decisions that maximize the expected cumulative reward. As an example, if an agent is given the task of recommending personalized content to improve a student's learning activities by maximizing long-term rewards to reach a goal, then the agent has two options: it can either recommend course content/material that it has previously recommended and is familiar with (using the exploitation technique), or it can try new personalized content that it has never used before (using the exploration technique).

As is well known in the field of RL, the choice between exploration and exploitation is based on a “greedy policy”, represented by ε. The greedy policy ε is altered throughout training to strike a balance between exploration and exploitation. To progressively transition from pure exploration to exploitation, the method begins with ε=1, representing pure exploration, and as the method iterates, the value decreases down to, for example, ε=0.8, progressing from pure exploration to exploitation. Using a greedy policy, the RL agent aims to maximize its expected cumulative reward by always choosing the action it believes to be the best at each state. This is performed based on the agent's learned value function or action-value function, which estimates the expected long-term rewards for each action in a given state. Formally, a greedy policy is defined by π(s)=argmax Q(s, a), where π(s) represents the policy's action selection for state s, and Q(s, a) represents the estimated Q-value of taking action a in state s.

At step 20, the action is selected. In RL, the selection of the next action is based on the learned Q-values, which represent the expected cumulative rewards for each action in a given state. The action selection in Q-learning follows the exploration-exploitation strategy described above, based on the greedy policy ε. Specifically, the action is based on its reward, and the agent always chooses the optimal action. Thus, the agent generates the maximum reward possible for the given state. In greedy action selection, the agent uses both exploitation to take advantage of prior knowledge and exploration to look for new options. The greedy approach selects the action with the highest estimated reward most of the time. The aim is to have a balance between exploration and exploitation. Exploration allows some room for trying new things, sometimes contradicting what has already been learned. With a small probability of ε, the choice is made to explore; i.e., not to exploit what has already been learned so far. In this case, the action is selected randomly, independent of the action-value estimates. Over a theoretical infinite number of trials, each action is taken an infinite number of times. Thus, the greedy action selection policy is ensured to discover the optimal action.

Once the action has been selected at step 20, the next state is calculated at step 22 using equation (1). The input for the calculation taking place at step 22 is the state sₜ and the action aₜ. The calculation performed at step 22 outputs the next state sₜ₊₁. The process iterates to the next state at step 28, where the input is state sₜ₊₁ calculated at step 22. The rewards corresponding to the states and actions, such as those represented by the matrix in equation (3) above, may be stored in a database 24 in any suitable type of non-transitional computer readable memory. The reward from the matrix is obtained at step 26, which returns the reward value Rₜ for application in the RL algorithm (step 30), where the action-value function is updated using equation (2) above. Equation (2) calculates the sum of discounted factor rewards and shows the best next state that will eventually lead to receiving the maximum reward.

The measured student interests will be averaged by the number of times that the agent acquired the same state (S) transition (from step 13) and the averaged values will be stored in database 24 as representative reward data Rₜ. At this time, the reward data Rₜ will be normalized. The interaction between the agents and the environment must be simulated by allocating the reward Rₜ to a chosen action a in each state S to update the action-value function Q(sₜ, aₜ) using equation (1). Once the reward database is developed, the agents will not be required further, since the database 24 contains all the actual interactions and related preferences for recommendations. At step 26, the reward Rₜ is referred from the database 24 depending on the state transition (S) and the selected reward is used to update the action value function at step 30 using equation (2).

The maximum value for the next state is recorded at step 32 and the decision to terminate the process is made at step 34. The termination of the RL model training at step 36 depends on various factors, such as the convergence of the model's performance, predefined stopping criteria, or available computational resources. Additionally, training may be stopped when the performance of the RL agent reaches a satisfactory level. This can be determined by achieving a desired level of reward, accuracy or any other evaluation metric specified for the task. The agent's performance may be monitored during training, and if it consistently meets the desired criteria, the training can be considered successful.

Training will be terminated after a fixed number of iterations, episodes, or time steps. This approach can be useful when there is a limited amount of time or computational resources available. The model is trained for the predetermined duration, and once the limit is reached, the training process is stopped. If the process is not terminated at step 34, then the state is updated at step 38 based on updating of the Q table using equation (1), and the process begins again.

Method 10 of FIG. 1 is a Q-learning approach, which is a model-free RL algorithm to learn the value of an action in a particular state. Q-learning does not require a model of the environment, allowing it to handle problems with stochastic transitions and rewards without requiring adaptations. For any finite Markov decision process (FMDP), Q-learning finds an optimal policy in the sense of maximizing the expected value of the total reward over any and all successive steps, starting from the current state. Q-learning can identify an optimal action-selection policy for any given FMDP, given infinite exploration time and a partly-random policy. As discussed in detail above, the Q-function is the function that the algorithm computes, representing the expected rewards for an action taken in a given state.

The Q-learning embodiment may be extended to a multi-agent system, particularly using Multi-Agent Q-learning, which is an extension of the traditional Q-learning algorithm that allows multiple agents to interact and learn in an environment. For each agent, a Q-table is initialized that stores the estimated Q-values (i.e., the expected cumulative rewards) for each state-action pair. Multiple episodes of interaction and Q-value updates are repeated to converge to an optimal or near-optimal policy. For each time step, each agent selects an action based on its Q-values and the exploration-exploitation strategy, similar to the previous embodiment. Each agent can obtain its policy by selecting the action with the highest Q-value in each state, and then the learned policies are combined in the final loop to maximize the cumulative reward. Once each agent has learned its policy independently, these policies can be combined in various ways to improve overall performance or coordination among agents.

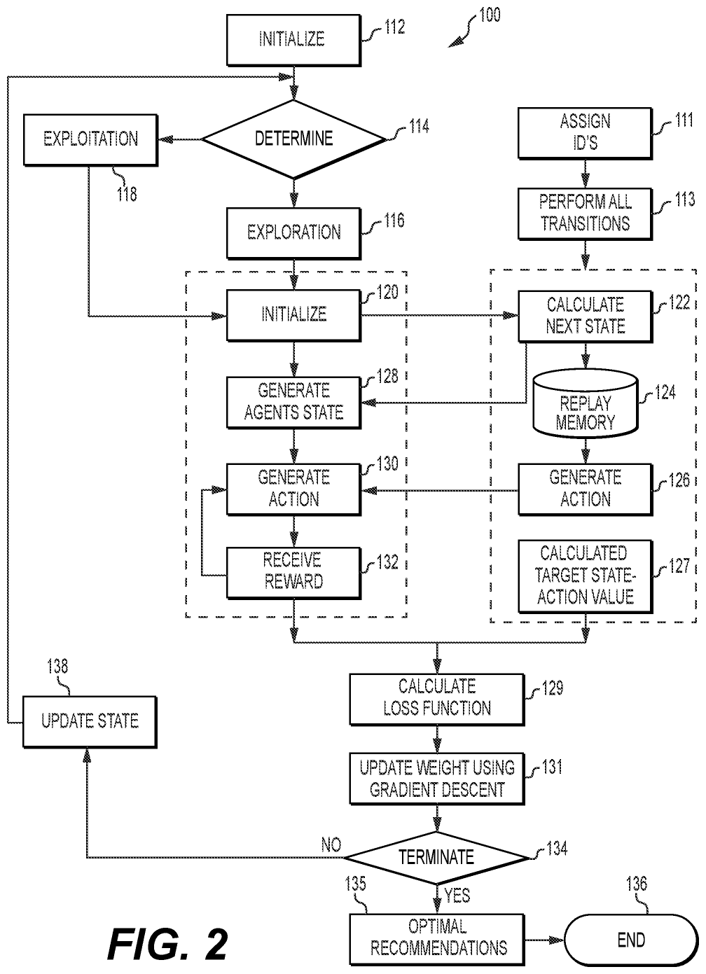

In the alternative embodiment of FIG. 2, rather than using Q-learning, as in the embodiment of FIG. 1, the RL method for educational course selection 100 uses Deep Q-learning. As in the previous embodiment, following start of the method, initialization of the agents and states of the agents based on the environment is performed at step 112; i.e., initialization of the action (a) and states (S) of the agents. This can be represented as a tuple: {N, S, A₁, . . . , A_{N}, P, R₁, . . . , R_{N}}, where N is the number actions; S is the environment state, s∈S; A_{N} represents the action space n, aₙ∈Aₙ where n=1, 2, . . . , N; P represents the state transition, where P: S×A₁× . . . ×Aₙ×S; and R_{N} represents the rewards achieved by executing aₙ∈A_{N} in S, where n=1, 2, . . . , N. Unlike the previous embodiment, at initialization step 112, initialization begins with arbitrary Q-value estimates.

Similar to the previous embodiment, at step 111, identification (ID) numbers are allocated to all of the action (a) forms (e.g., click reading, click writing, recommend a quiz, click a video, recommend the next course, recommend a game, click an ad, etc.), and all the state (S) transitions (e.g., reading, writing, taking exams, pausing, watching, skipping or stopping, getting bored, resting/sleeping, being entertained, playing games, being idle, quitting study, etc.) will be operated for several periods among all the IDs by multiple agents at step 113.

A determination is made at step 114 whether exploration or exploitation will be used. As discussed above with respect to the previous embodiment, exploration techniques (step 116) are applied to the process for trying new actions or policies to gather more information about the learning environment in order to maintain the students' preferences in the future and influence on future learning choices/decisions. On the other hand, exploitation techniques (step 118) are applied to the process for using the current knowledge or preference level of the student to make decisions that maximize the expected cumulative reward. As an example, if an agent is given the task of recommending personalized content to improve a student's learning activities by maximizing long-term rewards to reach a goal, then the agent has two options: it can either recommend course content/material that it has previously recommended and is familiar with (using the exploitation technique), or it can try new personalized content that it has never used before (using the exploration technique).

As is well known in the field of RL, the choice between exploration and exploitation is based on a “greedy policy”, represented by ε. The greedy policy ε is altered throughout training to strike a balance between exploration and exploitation. To progressively transition from pure exploration to exploitation, the method begins with ε=1, representing pure exploration, and as the method iterates, the value decreases down to, for example, ε=0.8, progressing from pure exploration to exploitation. Using a greedy policy, the RL agent aims to maximize its expected cumulative reward by always choosing the action it believes to be the best at each state. This is performed based on the agent's learned value function or action-value function, which estimates the expected long-term rewards for each action in a given state. Formally, a greedy policy is defined by π(s)=argmax Q(s, a), where π(s) represents the policy's action selection for state s, and Q(s, a) represents the estimated Q-value of taking action a in state s.

Unlike the previous embodiment, initialization of the Q-value function, which is given by equation (1) above, which is the state and action value function based on the initial inputs of states and corresponding actions, does not occur until step 120. As in the previous embodiment, as non-limiting examples, the learning states may be seen as activities engaged in by a student, or the emotional/physical state of the student, in an online learning scenario. For example, the states may include watching a video lesson, reading, writing, getting bored, resting/sleeping, being entertained, playing a game, clicking on an ad, completing a course, and quitting/ending study. The states may be represented as S∈{0, 1, 2, 3, 4, 5, 6, 7, 8, 9, 10}, where each number state reflects the position of each student during the learning process. Non-limiting examples of the corresponding actions include recommending the next course, recommending the next video to watch, recommending a game or an ad, suggesting a future influence for personalized learning, making an improvement in recommending suitable content, influencing future learning choices, and attempting to maximize the student's satisfaction and minimize student interactions.

The next state is calculated at step 122 using equation (1). The input for the calculation taking place at step 122 is the state sₜ and the action aₜ. The calculation performed at step 122 outputs the next state sₜ₊₁. The process iterates to the next state at step 128, where the input is state sₜ₊₁ calculated at step 122. The rewards corresponding to the states and actions, such as those represented by the matrix in equation (3) above, may be stored in replay memory 124 in any suitable type of non-transitional computer readable memory.

The reward from the matrix is obtained at step 126, which returns the reward value Rₜ and the next action. Similar to the previous embodiment, a new action is generated at step 130 based on the current action and the reward generated at step 126, with an iterative reward process occurring between steps 132, where the reward is received, and step 130.

In Deep Q-Learning, a loss function is created at step 129 that compares the Q-value prediction from step 132 and a Q-target (step 127) and uses gradient descent (step 131) to update the weights of the Deep Q-Network to better approximate the Q-values. To calculate the loss at step 129, the difference between the temporal difference target (Q-Target) and the current Q-value (estimation of Q) is calculated using equation (3) below. During the learning process, Deep Learning (DL) minimizes the error estimated by the loss function by optimizing the weights, θ. Error or loss is measured as the difference between the predicted and actual results.

$$Loss function = ( R + γ {max}_{{α}_{t + 1}} {Q}_{n} ( {s}_{t + 1} , {a}_{t + 1} : {θ}^{target} ) - {Q ( s , a : {θ}^{predication} )}^{2} ) . \qquad ( 3 )$$

At step 131, the loss is backpropagated and the weights of the Q-network are updated using gradient descent and a learning rate α. At every iteration, the weights of the prediction network are updated, and after N iterations, the target network weights are updated together with the prediction network weights. The decision to terminate the process is made at step 134. The termination of the Deep Q-learning model training at step 136 depends on various factors, such as the convergence of the model's performance, predefined stopping criteria, or available computational resources. Additionally, training may be stopped when the performance of the RL agent reaches a satisfactory level. This can be determined by achieving a desired level of reward, accuracy or any other evaluation metric specified for the task. The agent's performance may be monitored during training, and if it consistently meets the desired criteria, the training can be considered successful. Prior to termination, the optimal recommendations are output to the student at step 135.

Training will be terminated after a fixed number of iterations, episodes or time steps. This approach can be useful when there is a limited amount of time or computational resources available. The model is trained for the predetermined duration, and once the limit is reached, the training process is stopped. If the process is not terminated at step 134, then the state is updated at step 138 based on updating of the Q table using equation (1), and the process begins again. The performance of the trained DRL process may be evaluated on a separate test set to assess its ability to make accurate recommendations.

The Deep Q-learning approach 100 is a variant of the Q-learning embodiment of FIG. 1 that uses a deep neural network (on the lefthand side of FIG. 2) to represent the Q-function, rather than a simple table of values. This allows the algorithm to handle environments with a large number of states and actions, as well as to learn from high-dimensional inputs. Experience replay is performed on the righthand side of FIG. 2, where the agent stores a subset of its experiences (state, action, reward, next state) in the memory buffer 124 and samples from this buffer to update the Q-function. This helps to decorrelate the data and make the learning process more stable. Target networks, on the other hand, are used to stabilize the Q-function updates (step 127). In this technique, a separate network is used to compute the target Q-values (i.e., the network on the righthand side of FIG. 2), which are then used to update the Q-function network on the lefthand side of FIG. 2. It should be understood that the optimized course recommendation(s) may be output to the student using any suitable type of interface, such as, but not limited to, a display in communication with a general practice computer.

The Deep Q-learning algorithm-based embodiment may be extended to a multi-agent implementation. In such an embodiment, the students and course content/material make up the environment and the roles of the agents are handled by DRL algorithms. In the context of DRL, an Actor-Critic algorithm is utilized, where the actor represents the policy, which is a mapping from states to actions. This algorithm tries to learn the optimal policy that maximizes the expected cumulative reward over time. The critic, on the other hand, represents the value function, which estimates the expected cumulative reward from a particular state under the current policy. The key idea in Actor-Critic is to use the critic's value function to evaluate the actor's policy. The critic provides feedback to the actor about the expected reward for a given state-action pair. The actor then uses this feedback to adjust its policy to select better actions in each state, leading to improved performance. In this embodiment, the state is given as a feature depiction for students, and action is defined as a feature depiction of course content. When a student wants a course, the agents are given a state representation (i.e., student's features) and a collection of action representations (i.e., the course competitors' features). The agents will choose the best course of action (e.g., recommend a list of course content to a student) and reward the learner with feedback. The reward is made up of click labels and an estimate of the student's activity level. All these recommendations and feedback reports will be saved in the agents' memory. The agent will use the data in memory to update its recommendation algorithm at every iteration. The model is trained using the collected data and the defined reward function. The training process can involve several iterations and hyperparameter tuning to optimize performance, similar to the single agent Deep Q-learning algorithm-based embodiment.

As a further alternative, a Multi-Agent Deep Q-learning (MADQN) structure may be used, which is an extension of Deep Q-learning for environments with multiple agents. This structure involves multiple agents interacting with the environment and learning their policies using deep neural networks to approximate the Q-values. The algorithm uses neural networks to approximate the Q-values and allows agents to learn from each other's experiences. For example, each agent learns from its own experiences and those of its teammates or opponents, making the learning process more complex compared to single-agent DQN. For each time step, each agent selects an action based on its Q-network and the exploration-exploitation strategy. The agents take their actions in the environment, and the environment responds with the next states and rewards for each agent. Each agent stores its experiences in the shared experience replay buffer, similar to the single-agent Deep Q-learning embodiment discussed above. Each agent can execute its policy independently, and then the learned policies are combined in the final loop to maximize the cumulative reward. Once each agent has learned its policy independently, these policies can be combined in various ways to improve overall performance or coordination among agents, similar to the single-agent Deep Q-learning embodiment discussed above.

It is to be understood that the RL method for educational course selection is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. A reinforcement learning (RL) method for educational course selection in real-time, comprising:
a) establishing, in real-time, an action space and a state space, wherein actions of the action space represent actions associated with educational material and states of the state space represent learning states associated with a student;
b) selecting, in real-time, an action from the action space;
c) calculating, in real-time, a next state space based on the selected action and a current state;
d) generating, in real-time, a reward based on the current state and the next state;
e) updating, in real-time, a Q-value in a corresponding Q-value table based on the reward; and
f) updating, in real-time, the state and returning to step b) when a final state is not reached, and outputting an optimized action to the student when the final state is reached, wherein the optimized action represents an educational course recommendation using a finite Markov decision process (FMDP).

2. The RL method for educational course selection as recited in claim 1, wherein the step of selecting the action from the action space comprises exploration using a greedy strategy.

3. The RL method for educational course selection as recited in claim 1, wherein the step of selecting the action from the action space comprises exploitation using a greedy strategy.

4. A reinforcement learning (RL) method for educational course selection in real-time, comprising:
a) establishing, in real-time, an action space and a state space, wherein actions of the action space represent actions associated with educational material and states of the state space represent learning states associated with a student;
b) initializing, in real-time, a current action of the action space and a current state of the state space;
c) calculating, in real-time, a next state space based on the current action and a current state;
d) generating, in real-time, a next action based on the next state;
e) updating, in real-time, the next action based on a reward;
f) calculating, in real-time, a loss function based on the updated next action and a target state-action value;
g) updating, in real-time, a weight of the loss function using gradient descent; and
h) updating, in real-time, the state and returning to step b) when a final state is not reached, and outputting an optimized action to the student when the final state is reached, wherein the optimized action represents an educational course recommendation using a finite Markov decision process (FMDP).

5. The RL method for educational course selection as recited in claim 4, wherein the step of initializing, in real time, the current action and the current state comprises exploration using a greedy strategy.

6. The RL method for educational course selection as recited in claim 4, wherein the step of initializing, in real time, the current action and the current state comprises exploitation using a greedy strategy.
